(19) United States
(12) Patent Application Publication
(10) Pub. No.: US 2026/0097801 A1
(43) Pub. Date: Apr. 9, 2026

(54) AUTONOMOUS DRIVING MODE SYSTEM AND METHOD

(71) Applicant: Weastec, Inc., Hillsboro, OH (US)

(72) Inventors: Adam S. Koloff, Columbus, OH (US); Chase M. Woodruff, Dublin, OH (US); Joshua H. Zaborowski, Columbus, OH (US); Kyle L. Sherrets, Marysville, OH (US); Victor R. Terhune, Washington Court House, OH (US)

(21) Appl. No.: 19/298,989

(22) Filed: Aug. 13, 2025

Related U.S. Application Data
(60) Provisional application No. 63/703,829, filed on Oct. 4, 2024.

(51) Int. Cl. B62D 1/181; B60W 50/14; B60W 50/16; B60W 60/00; B62D 1/04; B62D 1/10

(52) U.S. Cl. CPC B62D 1/181; B60W 50/16; B60W 60/0051; B62D 1/046; B62D 1/10; B60W 2050/143; B60W 2050/146; B60W 2540/215; B60W 2540/223; B60W 2710/20

(57) ABSTRACT

A positioning system of a vehicle capable of both manual driving and autonomous driving can change the position of various vehicle components when the vehicle is switched to autonomous driving at a level where a person in the driver's seat no longer needs to be engaged with typical manual driving functions and responsibilities. In one respect, a switch panel of a steering device such as a steering wheel is inactive and less accessible and visible to the person in the driver's seat when the vehicle is in a drive mode and moved to be more accessible and visible to the person in the driver's seat when the vehicle is being autonomously driven and in a relax mode.

### PRIORITY

This application claims priority to U.S. Provisional Patent Application Ser. No. 63/703,829, filed Oct. 4, 2024, entitled “Autonomous Driving Mode System and Method,” the disclosure of which is incorporated by reference herein.

### BACKGROUND

Autonomous vehicles can operate a vehicle in a manual drive mode that relies on the human driver for driving control or inputs, and a self or autonomous drive mode that relies on the human driver less or not at all. In the manual drive mode, an operator manually controls the various parameters of the vehicle such as direction, speed, acceleration, deceleration, and braking to thereby move the vehicle from one location to another location. In the self drive mode, the operator has little to no involvement in controlling one or more of these various parameters as the vehicle has automated these functions. As suggested above, there are various levels of autonomous driving where lower levels require or rely on the human driver action or intervention, and higher autonomous driving levels require or rely on no or less human driver action or intervention.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements.

FIG. 1A is a side view of a vehicle in a drive mode and including an operator seated in front of a steering wheel;

FIG. 1B is a side view of the vehicle of FIG. 1A, shown in a relax mode;

FIG. 2A is a perspective view of the vehicle of FIG. 1A as viewed from the operator and facing the steering wheel;

FIG. 2B is a perspective view of the vehicle of FIG. 1B, as viewed from the operator and facing the steering wheel;

FIG. 3A is a side view of the steering wheel of FIG. 1A;

FIG. 3B is a side view of the steering wheel of FIG. 1B;

FIG. 4A is a perspective view of the steering wheel of FIG. 1A;

FIG. 4B is a perspective view of the steering wheel of FIG. 1B;

FIG. 5A is a perspective view of a second example of a steering wheel, shown in drive mode;

FIG. 5B is a perspective view of the second example of the steering wheel of FIG. 5A, shown in relax mode;

FIG. 6 is a cross-section view of a concave bottom of the steering wheel of FIG. 1A;

FIG. 7 is a cross-section view of a convex bottom of a third example of a steering wheel.

FIG. 8 is a front view of an exemplary plurality of switches on a relax mode switch panel with icons associated with the switch locations.

### DETAILED DESCRIPTION

The present disclosure relates to an autonomous vehicle interior positioning system. More specifically, the present invention relates to autonomous vehicle steering device (i.e., a steering wheel), seat, pedal systems corresponding to a drive mode and a relax mode, and moving the systems between an orientation related to each of the drive mode and the relax mode. As described herein, the drive mode can be considered a manual mode where a person is driving the vehicle or a level of autonomous driving where the relax mode is not engaged. Also as described herein, the relax mode can be considered a level of autonomous driving where the person that would be driving the vehicle in the manual mode is no longer needed for driving the vehicle as that function is fully automated. Note that as used herein, the relax mode is a further mode within an autonomous driving mode environment and not required at all times with autonomous driving.

As mentioned, with autonomous driving vehicles, there can be different levels of autonomous driving. For instance, in some instances only speed is controlled autonomously, e.g., by acceleration and braking, but other functions like steering are manually controlled. In some other instances only steering is controlled autonomously, but other functions like speed, e.g., acceleration and braking, are manually controlled. In greater levels of autonomous driving both speed and steering are controlled autonomously. With these levels of driving automation, the person can still be considered to be doing the driving as there is a required level of engagement and attention required by the person in the driver's seat.

However, there are other levels of driving automation where the human driver can have minimal to no driving responsibility. For instance, in such cases no intervention from the human driver is needed, and at the most advanced levels of automated driving, the human driver can take their eyes off the road, take their hands off the steering wheel, take their feet off the pedals, and disengage from the mental steps of driving. It may even be possible with the most advanced automated driving vehicles for such vehicles to not include systems like a steering wheel, brake pedal, acceleration pedal, etc. However, in many instances vehicle manufacturers continue and will continue to include these systems such that the vehicles retain the option to have a human drive the vehicle even if not required.

When autonomous driving is advanced to the point where the human driver can disengage from dynamic driving tasks—where they can take their eyes off the road, take their hands off the steering wheel, take their feet off the pedals, and disengage from the mental steps of driving—they become just like a non-driving passenger. Like other non-driving passengers, they may want to physically relax, use a smartphone, tablet, laptop or other electronic device, have more engaging in-cabin conversations, read books, mail, documents, take video calls or more focused phone calls, listen more intently to audio content, take a nap or sleep, and/or enjoy in-cabin entertainment. To better achieve these activities in the fully autonomous driving vehicle, what is needed is an ability to make automated changes to the driver's environment or area or cockpit in a way where space and comfort for the human driver is increased, yet at the same time maintain within reach of the human driver controls to high-use functions and maintain or improve visibility to an instrument meter or cluster or display. In other words, while more space and comfort is desirable, it is still desirable to maintain key vehicle controls and/or features accessible to the human driver, as well as facilitating easy and efficient switching of the driver area or cockpit between a drive mode and a relax mode.

### I. Exemplary Drive Mode Interior Positioning

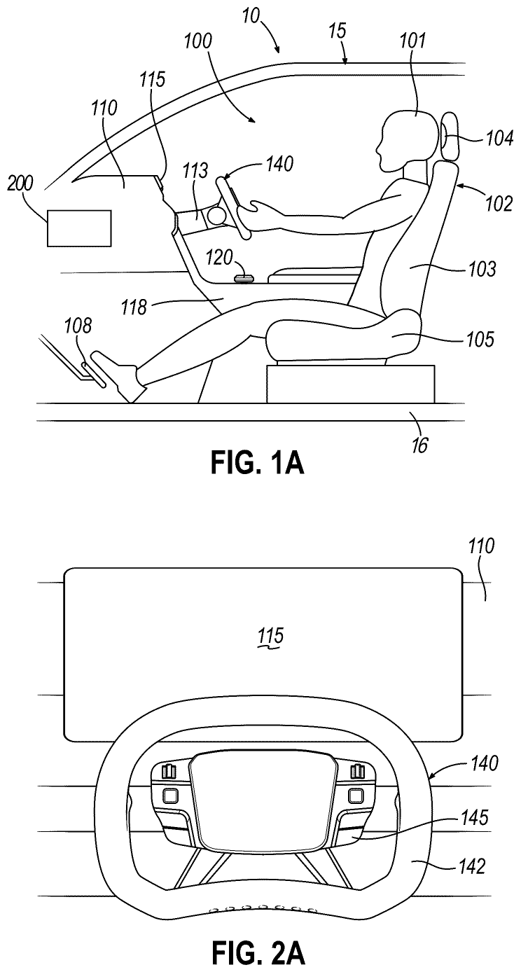

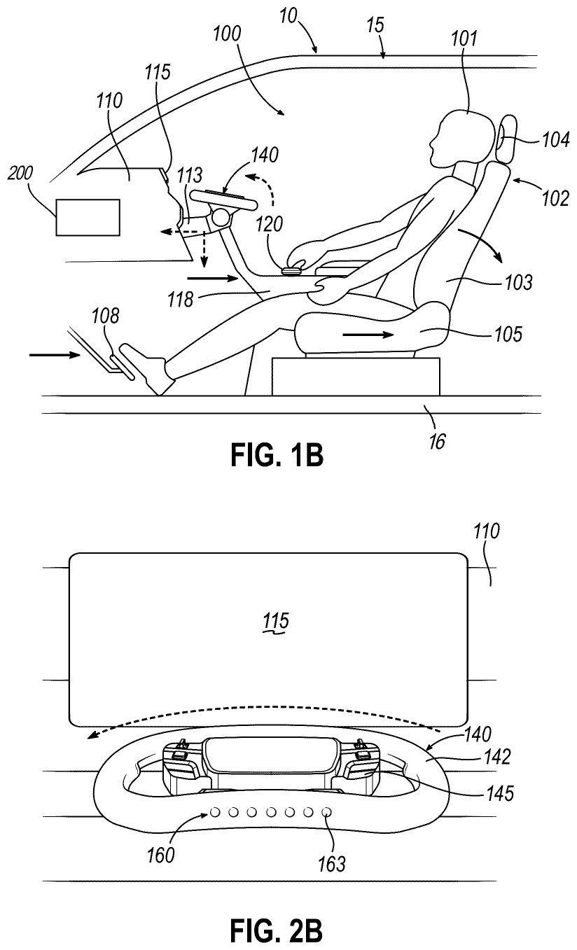

FIG. 1A shows a side view of vehicle 10 in a drive mode showing a vehicle roof 15 and a vehicle floor 16. Vehicle 10 has a first row 100 including an operator (also referred to as a driver, human, user, or person) sitting on a seat 102 having a seat back 103 with a speaker 104, and a seat bottom 105. Vehicle 10 also includes one or more pedals 108; a dash or dashboard 110 having a steering device or wheel 140 attached to a steering column 113 that leads to an instrument cluster 115. Vehicle 10 also has a center console 118 having a relax mode switch 120. In some other versions, relax mode switch 120 may be located in other places within vehicle 10 other than on center console 118. As those of ordinary skill in the art will appreciate in view of the teachings herein, vehicle 10 further includes other components and systems for operating vehicle 10 such as wheels, brakes, a gasoline or electric powered engine or motor, various safety components and systems, etc.

As shown, vehicle 10 is in drive mode where operator 101 is vertically supported by seat bottom 105 with operator 101 resting against seat back 103. Operator 101 is within reaching distance of steering wheel 140 to thereby drive vehicle 10. When operator 101 rotates steering wheel 140, the wheels change angle to thereby change a direction of vehicle 10. Operator 101 is further in reach of the one or more pedals 108 which can include a gas pedal, a brake pedal, and/or a clutch pedal which may be operable to increase, reduce, and maintain a speed of vehicle 10. Operator 101 is positioned adjacent to center console 118 and within reach relax mode switch 120 which will be described in more detail below. While relax mode switch 120 is shown positioned on center console 118, it may also be positioned on dash 110, seat bottom 105, steering wheel 140, or any location reasonably proximate operator 101. Instrument cluster 115 is operable to indicate pertinent vehicle 10 information to operator 101 which may include vehicle speed or velocity, engine speed, geographic position, drivetrain related parameters, autonomous driving level and status, and/or media related parameters.

FIG. 2A shows a perspective view of dash 110, instrument cluster 115, and steering wheel 140 with vehicle 10 in drive mode. Steering wheel 140, also referred to as a steering grip or steering device, includes a rim 142 for operator 101 to grip to thereby angle the wheels and thus steer vehicle 10. As will be described in greater detail below, steering wheel 140 includes a relax mode on switch 145 operable to transition the vehicle from drive mode to relax mode. When in drive mode shown in FIG. 1A, operator 101 may easily reach relax mode on switch 145 to thereby select and switch from drive mode to relax mode. In some instances, this change in mode may occur by a short actuation of relax mode on switch 145 whereas in other instances this may occur by a long actuation of relax mode on switch 145 to ensure unintended accidental actuation does not trigger the mode change.

The wheels of vehicle 10 may be angled by steering wheel 140 by a mechanical linkage, such as a rack and pinion steering assembly, or may be by steer-by-wire, where there is no mechanical linkage between steering wheel 140 and the wheels. In a steer-by-wire system, steering angles from steering wheel 140 are electronically interpreted to be reflected at the wheels via an electric motor. Steer-by-wire systems may be advantageous in fully autonomous driving situations because steering wheel 140 may remain stationary and in effect be bypassed to alter the position of wheels to steer the vehicle. With a mechanical linkage system, steering wheel 140 may change rotation angles with the wheels while in an autonomous driving mode that handles steering.

### II. Exemplary Relax Mode Interior Positioning

As mentioned, vehicle 10 is capable of autonomous driving such that no or minimal inputs are required from operator 101 in order to move locations. As mentioned above there can be various levels of autonomous driving. In the present examples, the relax mode is only able to be activated when in the autonomous driving mode, but it is not required to be in the relax mode when the vehicle is being autonomously driven. In other words, the vehicle can be driven autonomously without being in the relax mode. In this manner, even though vehicle 10 might be driven autonomously at some level, steering wheel 140 remains positioned at operator's 101 disposal. The relax mode, when activated, is however configured to provide more space and comfort to the person in the driver's seat when the vehicle is being autonomously driven.

To transition from the drive mode to relax mode, operator 101 may select either relax mode switch 120 or relax mode on switch 145. Upon such selection, numerous operations may take place as will be described below. Transitioning from drive mode to relax mode may be instantaneous or may be delayed. Such a delay may require operator 101 to select relax mode switch 120 or relax mode on switch 145 multiple times consecutively or for a predetermined amount of time, such as for 3 seconds. Communication to operator 101 of such a selection and/or transition may be visual, such as via instrument cluster 115, audible, such as via speaker 104, or tactile/haptic via switches 120, 145, steering wheel 140, and/or seat 102. In some examples haptic feedback can be provided by using thin piezoelectric actuators, eccentric rotating mass motors, linear resonant actuators, voice coil actuators, or more advanced methods like electroactive polymers, to create the vibration.

In relax mode, vehicle 10 may be significantly autonomous and thus require no or minimal inputs from operator 101 in order to drive from one location to another. In relax mode, the level of autonomous driving can be considered “hands off the wheel and eyes off the road.” In relax mode, vehicle 10 may be capable of steering vehicle 10 without use of steering wheel 140 and may be operable to increase, reduce, and/or maintain vehicle speed without use of the one or more pedals 108.

FIG. 1B shows a side view of vehicle 10 in relax mode where several components of first row 100 have moved relative to their positions in FIG. 1A to create a more spacious environment for operator 101. Specifically, seat back 103 pivots backwards relative to seat bottom 105, seat bottom 105 (and thus seat back 103) moves backwards and away from dash 110, center console 118 (and thus relax mode switch 120) moves backwards to thus stay proximate with operator 101. Note that having relax mode switch 120 remain proximate to the operator can be useful where relax mode switch 120 is configured to also be actuated to return to the drive mode from the relax mode. Further, steering wheel 140 rotates away from operator 101 and draws downwards toward vehicle floor 16 and towards dash 110 via steering column 113. The one or more pedals 108 further move backwards to stay within reach of operator 101.

FIG. 2B shows a perspective view of dash 110 while in relax mode. Specifically, and as described above, steering wheel 140 has rotated, moved backwards and down. In this configuration, an operator's view of instrument cluster 115 may be unobstructed by rim 142 of steering wheel 140. Further, relax mode on switch 145 may be inoperable since relax mode has been engaged. However, a relax mode switch panel 160 of steering wheel 140 is exposed to operator 101 in relax mode. Relax mode switch panel 160 includes several or a plurality of switches 169 operable to adjust high-use features such as media, autonomous settings, and voice assistant. Relax mode switch panel 160 may be in an inoperable state while in drive mode of FIGS. 1A and 2A, but transition to an operable state while in relax mode of FIGS. 1B and 2B. While in the operable state, relax mode switch panel 160 may be illuminated and configured to send commands to a control system 200 for performing specific tasks. While in the inoperable state, relax mode switch panel 160 may be dimmed or not illuminated and not operable to send related commands to control system 200. Relax mode switch panel 160 may include a relax mode off switch 163 operable to transition from relax mode to drive mode, which may entail vehicle 10 transitioning to manual mode or remain in autonomous driving mode but with the same or similar interior positioning setup as used in the manual mode. As with transitioning to relax mode, transitioning from relax mode may be instantaneous or delayed and include visual, audible, and tactile indicators, alerts, or notifications.

### III. Exemplary Steering Wheel Positions in Drive Mode and Relax Mode

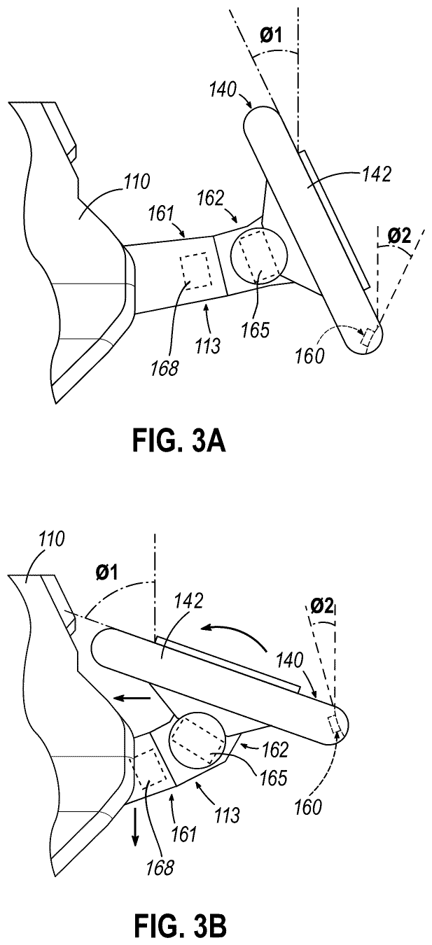

FIG. 3A shows an enlarged side view of dash 110, steering column 113, and steering wheel 140 in drive mode. As shown, steering column 113 may include lower column 161, upper column 162, motor 165, and motor 168. Motor 165 is used to rotate the steering device to 0 degrees, which is the orientation of the steering device when the vehicle's wheels are pointed to steer the vehicle straight. Motor 168 transitions steering wheel 140 to the rotated position of relax mode by moving upper column 162 relative to lower column 161. Lower column 161 may be further configured to move towards dash 110 and downwards via motor 165, 168, or other motors within dash 110, steering column 113, or elsewhere. For instance, lower column 161 may move in a telescopic fashion. In the present example, motor 165 is located on a portion of the steering column 113, and motor 168 is located within the steering column 113. In other versions, more or fewer motors may be used and the motors may be located in alternate locations within the vehicle as will be appreciated by those of ordinary skill in the art in view of the teachings herein.

As shown, rim 142 of steering wheel 140 defines angle θ1 with vertical reference and relax mode switch panel 160 defines angle θ2 with vertical reference. θ1 and θ2 change between drive mode and relax mode to thus change a viewable angle of each of rim 142 and relax mode switch panel 160. In doing so, rim 142 may be viewable when in drive mode but have reduced viewability when in relax mode. Further, relax mode switch panel 160 may be largely obscured or hidden when in drive mode but exposed in relax mode. Specifically, θ1 may be approximately 25 degrees when in drive mode and 85 degrees when in relax mode, plus or minus 10 degrees. θ2 may be approximately 35 degrees when in drive mode and −25 degrees in relax mode, plus or minus 10 degrees. Note that θ2 in relax mode is indicated with a negative angle based on the angle now being on the opposite side of the vertical reference. FIG. 3B shows steering column 113 and steering wheel 140 in relax mode with upper column 162 rotated relative to lower column 161 and lower column 161 pulled back into dash 110. Relax mode switch panel 160 is thereby exposed to operator 101 through a changed θ1 and θ2.

Motor 165 as well as seat 102, center console 118, and one or more pedals 108 can move at a fast speed and a slow speed. These components may operate at a fast speed upon a predefined condition being met. Such a predefined condition may be, but is not limited to, an obstacle in the path of vehicle 10, a vehicle 10 malfunction, inclement weather conditions, and/or loss of a signal. In such cases, vehicle 10 may automatically transition from relax mode to drive mode upon an occurrence of one of the predefined conditions. These components operate at slow speed upon operator 101 transitioning between drive mode and relax mode and in an absence of the predefined condition.

### IV. Exemplary Steering Wheels and Control Layouts

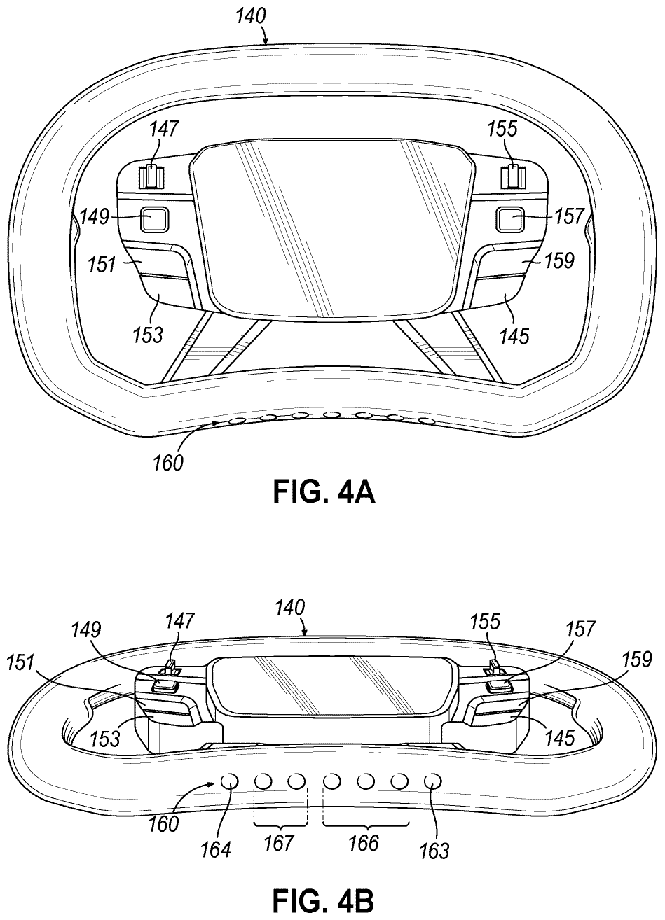

FIGS. 4A-4B show detailed perspective views of steering wheel 140 in drive mode and relax mode, respectively. Steering wheel 140 is shown in the form of a largely square wheel but may alternatively be in the form of a yoke, a circular wheel, a flat-bottom steering wheel, or a steering stick. A front face of steering wheel 140 includes lighting switch 147, media joystick 149, info switch 151, voice assistant switch 153, wiper switch 155, cruise joystick 157, autonomous drive on switch 159, relax mode on switch 145. Relax mode switch panel 160 may include relax mode off switch 163, voice assistant switch 164, volume switches 167, and other programable switches 166.

While relax mode switch panel 160 is shown at the bottom of steering wheel 140, it may alternatively be positioned at the top of steering wheel 140. In such an example, steering wheel 140 may rotate downwards instead of upwards to thereby expose relax mode switch panel 160 to operator 101 when in relax mode and to obscure relax mode switch panel 160 when in drive mode. In view of the teachings herein, other locations for relax mode switch panel 160, where relax mode switch panel 160 can be exposed to operator 101 in one configuration or mode and not exposed in another configuration or mode, will be apparent to those of ordinary skill in the art.

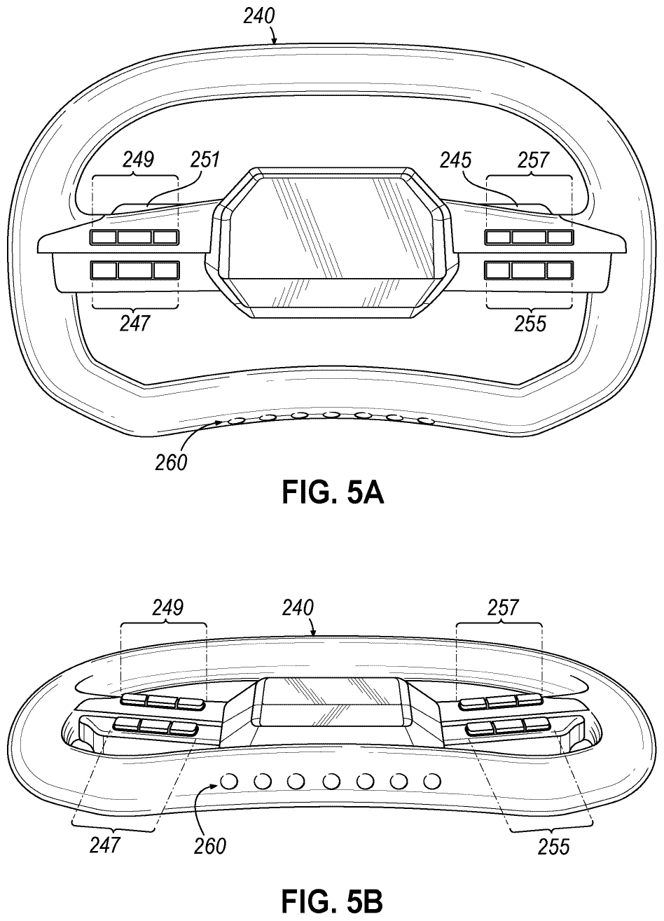

FIGS. 5A-5B show detailed perspective views of a second steering wheel 240. Steering wheel 240 may be substantially equivalent in form and function to steering wheel 140 but for the noted differences herein. Steering wheel 240 includes relax mode on paddle 245, lighting switches 247, media switches 249, info paddle 251, wiper switch 255, cruise switch 257, and relax mode switch panel 260. Relax mode switch panel 260 may be substantially equivalent to relax mode switch panel 160.

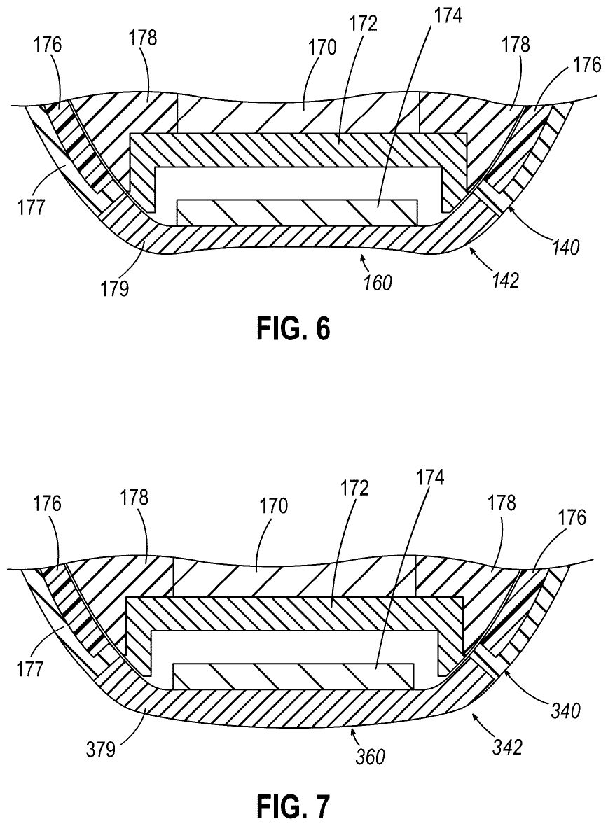

FIG. 6 shows a cross-section of steering wheel 140 having a concave bottom, where the relax mode switch panel 160 is located, while FIG. 7 shows a cross-section of steering wheel 340 having a convex bottom where the relax mode switch panel 360 is located. The radius of curvature maximum is 27 mm in the example with the concave bottom, and 25 mm in the example with the convex bottom. Specifically, relax mode switch panel 160, 360 is shown incorporated into rim 142, 342 such that relax mode switch panel 160, 360 is protected from impact and fluids but still operable to receive commands from operator 101. Relax mode switch panel 160, 360 may be operable by operator 101 via capacitive sensing, an impedance sensing, a piezoelectric sensing, a strain gauge, a force load cell, a single pole single throw switch, a momentary switch, and/or an ultrasonic sensing through rim 142, 342. Relax mode switch panel 160, 360 is operable to detect when an operator's hand is positioned proximate to the relax mode switch panel. Such a detection may be useful where vehicle 10 needs to stabilize steering wheel motion to accept an input from the operator at relax mode switch panel 160, 360, or where a hand on steering wheel 140, 340 is necessary to remain in continued autonomous driving. Similarly, such detection may be useful where vehicle 10 needs to stabilize steering wheel motion before and/or during an operator engaging with the relax mode switch panel 160, 360, i.e., by pressing on the relax mode switch panel 160, 360 to actuate one of the sensors. This in turn avoids the issue where the steering wheel 140, 340 moves in response to the operator interacting with the relax mode switch 160, 360. In other words, in at least some versions, the system is configured so that the steering wheel 140, 340 is stabilized during operator's use of the relax mode switch panel 160, 360 to avoid any unintentional steering effect that might be otherwise caused by the steering wheel 140, 340 moving when the operator engages with the relax mode switch panel 160, 360. Additionally, in some versions a strain gauge sensor is used in combination with capacitive sensing to confirm a user has activated the relax mode switch panel 160, 360. This dual sensing approach provides for a robust method for avoiding false-positive or false-negatives when detecting an activation of the relax mode switch panel 160, 360.

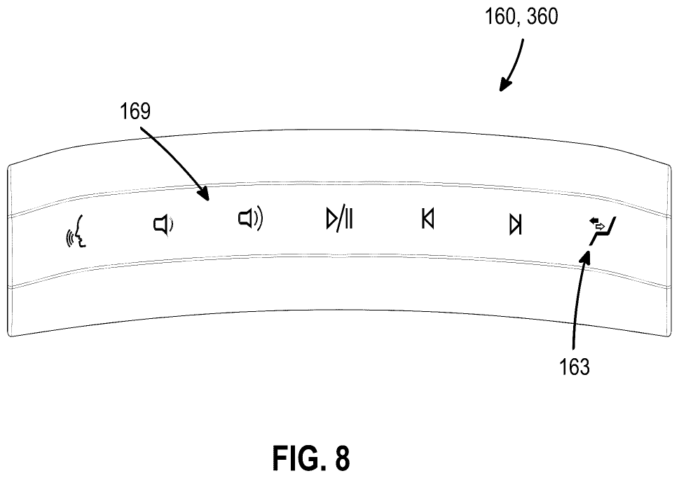

As shown in FIGS. 6 and 7, steering wheels 140, 340 comprises a hub core 170, areas of polyurethane fill 178, a heated pad 176, a cover 177 (e.g., made from leather, synthetic leather, or other suitable steering wheel cover material), and the relax mode switch panel 160, 360. The relax mode switch panel 160, 360 is comprised of a panel top 179, 379, printed circuit board with sensors 174, and a panel base 172. Steering wheels 140, 340 have a rigid structure and this includes, in the present example, the relax mode switch panel 160, 360 where the user presses to actuate switches on switch panel 160, 360 such as relax mode off switch 163 among others. In at least one example as mentioned above, relax mode switch panel 160, 360 includes icons or figure marks that indicate the location of switches for actuation (see FIG. 8). The relax mode switch panel 160, 360 and its switches, in at least some versions, are not only inactive when not in the relax mode, but also are hidden to the operator when not in the relax mode. For instance, in the relax mode, relax mode switch panel 160, 360 may be illuminated to reveal the icons associated with the switches but not be illuminated in the drive mode so as to not be visible to the operator. In such versions, a transparent or semi-transparent plastic made by injection molding may be used over the relax mode switch panel 160, 360 is preferable. However, thin layers of wood, leather, sued, or other non-plastic materials may be used. In those cases, illuminating the icons remains feasible.

### V. Miscellaneous

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

As used herein, an element or step recited in the singular and proceeded with the word “a” or “an” should be understood as not excluding plural of said elements or steps, unless such exclusion is explicitly stated. Furthermore, references to “one example” or “an example” are not intended to be interpreted as excluding the existence of additional examples that also incorporate the recited features. The use of “including,” “comprising,” or “having” and variations thereof herein is meant to encompass the items listed thereafter, and equivalents thereof, as well as additional items.

As used herein in the specification and claims, the terms “about,” “approximately,” “substantially,” “generally,” or similar terms used for any numerical values or ranges indicate a suitable dimensional tolerance, or other form of reasonable expected range, that allows the part or collection of components to function for its intended purpose as described herein. More specifically, these terms may refer to the range of values that are within ±10% of the recited value (e.g., “about 100” may refer to the range of values from 90 to 110, including 90, 110, 100, and all other values within the range of 90 and 110). Any numerical range recited herein is intended to include all sub-ranges subsumed therein. In other contexts, these terms are used herein to represent the degree by which a quantitative representation may vary from a stated reference without resulting in a change in the basic function of the subject matter at issue. Stated another way, these terms shall be understood to include a range of conditions or results that provide a functional equivalent to an explicitly stated condition or result. For instance, an apparatus including a component that is “substantially straight” may provide a result or effect that is functionally equivalent to a result or effect that would be achieved by the same apparatus including the same component in a perfectly straight configuration. The range implied by the term “substantially” should also be read to include the perfect result that is within that range.

I/We claim:

1. An autonomous driving positioning system, wherein the system comprises:
(a) a vehicle configured for being driven in a manual mode where a person drives the vehicle, or being driven in an autonomous mode where all driving functions are handled automatically instead of by the person;
(b) an input device configured to receive an input from the person only when the vehicle is in the autonomous mode; and
(c) a control system configured to change a position of the input device relative to the person from a first state to a second state when the vehicle is in the autonomous mode, and wherein in the second state the input device is located within reach of the person so the person can provide the input to the input device while the vehicle is in the autonomous mode.

2. The system of claim 1, comprising a first switch that is actuatable by the person, wherein actuation of the first switch causes the control system to change the position of the input device relative to the person from the first state to the second state.

3. The system of claim 2, wherein the switch is only actuatable when the vehicle is in the autonomous mode.

4. The system of claim 2, wherein the first switch is further actuatable to restore the position of the input device relative to the person to the first state from the second state.

5. The system of claim 1, wherein the input device comprises a steering device.

6. The system of claim 5, wherein the steering device is configured to rotate to steer the vehicle in the manual mode, yet the steering device is also configured to not rotate when steering the vehicle in the autonomous mode.

7. The system of claim 5, wherein the steering device is configured to rotate to steer the vehicle in the manual mode and the autonomous mode.

8. The system of claim 5, wherein the control system includes a sensor to determine when a hand of the person is proximate to the steering device.

9. The system of claim 5, wherein the steering device includes a switch panel having a plurality of switches wherein the switch panel is located along a bottom portion of the steering device.

10. The system of claim 9, wherein the control system is configured to move the steering device when transitioning from the autonomous mode to the manual mode to obscure the switch panel from the person, wherein the control system is configured to move the steering device when transitioning from the manual mode to the autonomous mode to expose the switch panel to the person.

11. The system of claim 5, wherein the steering device comprises a steering wheel.

12. The system of claim 9, wherein the plurality of switches of the switch panel are configured to illuminate when the input device is in the second state and the illumination is off when the input device is in the first state.

13. The system of claim 9, wherein the plurality of switches of the switch panel use a select one of a capacitive sensing, an impedance sensing, a piezoelectric sensing, a strain gauge, a force load cell, a single pole single throw, a momentary, and an ultrasonic sensing.

14. The system of claim 1, wherein the control system includes an electric motor configured to move the input device from the first state to the second state at a first speed in response to actuation of the first switch, and wherein the electric motor is configured to move the input device from the second state to the first state at a second speed in response to a predefined condition being met, wherein the second speed is faster than the first speed.

15. The system of claim 1, further comprising a second switch configured to be actuated by the person to transition the vehicle from the manual mode to the autonomous mode.

16. The system of claim 15, wherein the control system is configured to alert the person that a select one or more of the first switch, the second switch, and one or more of the plurality of switches of the switch panel is actuated by at least one of: an audible alert, a visual alert, and a haptic alert.

17. The system of claim 1, further including an instrument cluster configured to display parameters of the vehicle, wherein the input device is configured to move out of a line of sight between the person and the instrument cluster when the input device is in the second state.

18. The system of claim 2, further including a steering column, a seat, a pedal, and a center console, wherein one or more of the steering column, the seat, the pedal, and the center console are configured to change position upon actuation of the first switch when the vehicle is in the autonomous mode.

19. A method of configuring an interior of a vehicle capable of autonomous driving to accommodate a person in a driver's seat, the method comprising:
(a) activating an autonomous driving mode whereby the vehicle switches from being manually driven by the person in the driver's seat to being driving autonomously without assistance from the person in the driver's seat; and
(b) actuating a first switch to cause movement of a steering device from a first position to a second position, wherein the steering device comprises a switch panel comprising a plurality of switches, wherein in the first position the plurality of switches of the switch panel are not actuatable, and in the second position the plurality of switches of the switch panel are actuatable, wherein movement of the steering device to the second position increases the visibility and accessibility of the switch panel to the person in the driver's seat.

20. The method of claim 19, wherein actuating the first switch causes movement of the driver's seat backwards away from the steering device and also reclines the driver's seat.

21. The method of claim 19, wherein actuating the first switch causes the steering device to rotate to 0 degrees and tilt upward toward a roof of the vehicle.

22. The method of claim 19, further comprising:
(c) a control system responsible for autonomous driving recognizing a first condition, wherein at the occurrence of the first condition the movements made by actuating the first switch are automatically reversed and audible and visual alerts are provided notifying the person in the driver's seat to resume manual driving.
